(19) United States
(12) Patent Application Publication
(10) Pub. No.: US 2011/0300525 A1
(43) Pub. Date: Dec. 8, 2011

(54) Workload Management System

(76) Inventors: Ranvir Wadera, San Mateo, CA (US); Jeanne Lowell, Menlo Park, CA (US)

(21) Appl. No.: 13/152,552

(22) Filed: Jun. 3, 2011

Related U.S. Application Data
(60) Provisional application No. 61/351,873, filed on Jun. 5, 2010.

(51) Int. Cl. G09B 3/00

(52) U.S. Cl. 434/350

(57) ABSTRACT

A system and method designed to enable schools to proactively manage and analyze a student's workload. The workload management system helps identify, for each individual student, workload hotspots early and helps teachers and administrators in schools take action to mitigate the stress that such workload hotspots create.

### CLAIM OF PRIORITY

This application claims priority to U.S. Ser. No. 61/351,873 filed Jun. 5, 2010, the contents of which are fully incorporated herein by reference.

### FIELD OF THE INVENTION

The invention relates to a computerized system for managing student workload within a school environment, and more particularly to a workload management system that may help identify workload hotspots for student and may help teachers and administrators mitigate the stress that such workload hotspots may otherwise create.

### BACKGROUND OF THE INVENTION

The present invention relates to a system and method to enable institutions to manage workloads. More particularly, the present invention relates to a system and method for schools to proactively manage and analyze student workload.

Many schools have policies to better manage student workload and, therefore, stress. The purpose of such policies is to ensure that no student should have more than a certain number of tests and/or homework assignments on any given day. However, this is presently very difficult for schools to accomplish because at the time that a teacher is scheduling assessments and/or assignments they may not know the workload of students in their classes. These students may also have elective classes and each student would then have a separate class schedule and load for those elective classes. Therefore, schools that seek to manage student workload typically require interaction of many teachers to meet and manage a student's calendar. This present system results in a situation wherein many students report that their workload and, therefore, stress levels are aggravated by a high amount of tests and homework scheduled in the same time period. This is because teachers, who assign such tests and homework and are most closely engaged with the students on a daily basis, lack the tools and visibility to be able to balance such workload for each individual student over time.

Therefore, there is a need for a system and method that overcomes the inefficiencies of the traditional workload management programs and improves the efficiency of a recipient's workload by giving visibility into the estimated time for work, frequency of overlapping activities of students and their spread across time and permitting institutions, like high schools, to proactively manage the students' workloads.

### SUMMARY OF THE INVENTION

It is an object of the present invention to provide a computerized system and method for an institution that may enable the institution to automatically and proactively manage a workload of one or more members.

It is yet another object of the present invention to provide a system and method to an institution such as, but not limited to, to a school or university, so that they may define a unique workload profile for each student and which may provide a new and improved way to view and analyze the activities of any student to get visibility into their workload and where their time is spent, thereby allowing for better workload management.

It is yet another object of the present invention to help identify workload hotspots early and to help teachers and administrators in schools take action to mitigate the stress that such workload peaks create.

These and other objects of the invention may be accomplished by any known means, including by individuals, one or more computer systems, communication systems, such as, but not limited to, emails or the like, or some combination thereof.

### BRIEF DESCRIPTION OF THE DRAWINGS

Additional aspects, features, and advantages of the invention, both as to its structure and operation, will be understood and will become more readily apparent when the invention is considered in light of the following description made in conjunction with the accompanying drawings that illustrate certain non-limiting embodiments of the disclosure, wherein:

FIG. 1a is a monthly load analysis view of the workload management system according to one embodiment of the invention.

FIG. 1b is a student load analysis view of the workload management system according to one embodiment of the invention.

FIG. 2 is a spread analysis view of the workload management system according to one embodiment of the invention.

FIG. 3a is a monthly view of a time demand analysis according to one embodiment of the invention.

FIG. 3b is a student view of a time demand analysis according to one embodiment of the invention.

FIG. 4 is an analysis view of students with the workload exceptions over time according to one embodiment of the invention.

FIG. 5 is an analysis view of students with the most workload exceptions over time according to one embodiment of the invention.

FIG. 6 is an analysis view of workload exceptions over time and number of students impacted according to one embodiment of the invention.

FIG. 7a is an analysis view of students with exception days for a time period by grade according to one embodiment of the invention.

FIG. 7b is an analysis view of students who have had exception days by having crossed the assessment threshold on any given day.

FIG. 8a is a user view of the teacher planner with workload options according to one embodiment of the invention.

FIG. 8b is a user view of the teacher planner with student information according to one embodiment of the invention.

FIG. 9a is a weekly view of the student planner according to one embodiment of the invention.

FIG. 9b is a list view of the student planner according to one embodiment of the invention.

FIG. 9c is a chart view of the student planner according to one embodiment of the invention.

FIG. 9d is a list view of the student planner according to one embodiment of the invention that shows the tasks that student MUST do and MAY do on any given day.

FIG. 10 is an exemplary overall workflow of the system and how each user interacts with the workload management system.

FIG. 11 is an exemplary interaction and workflow that teachers have with the system.

FIG. 12 is an exemplary interaction and workflow that students have with the system.

FIG. 13 is an exemplary interaction and workflow that parents have with the system.

### DESCRIPTION OF THE PREFERRED EMBODIMENTS

The preferred embodiments of the present invention will now be described with reference to the drawings. Identical elements in the various figures are identified with the same reference numerals.

In a preferred embodiment, the workload management system (WMS), the workload of a school student may be managed using a workload planning and analysis system running on an electronic controller, such as, but not limited to, an electronic computer, a smart phone, a mobile device or some combination thereof. The WMS may also incorporate auxiliary processing and storage equipment such as, but not limited to, an electronic database and one or more machine readable data files, or some combination thereof. The WMS may, for instance, automatically help identify workload hotspots early and may help teachers and administrators in schools take action to mitigate the stress that such workload peaks may create. By way of example, the WMS may be concerned with groups and members and their respective workflow tasks. These workflow tasks may, for instance, be tasks such as, but not limited to, assessments, events and assignments, or some combination thereof.

In this exemplary system, groups and members may, for instance, represent entities such as, but not limited to, classes and students.

Assessments may, for example, be tests of various types that the school wants to track and take into account for load management.

Assignments may, for example, be all the homework that teachers assign to their classes wherein, each homework assignment may have an estimated time component which is used to calculate student workload.

Events may, for example, be activities like meetings, appointments, sporting activities, etc. that students may participate in.

In managing workload, the WMS may calculate a workload for a student, which by way of example, may be a consolidation of all the workflow tasks, i.e., the activities the student participates in for academic and extracurricular purposes, such as, but not limited to, elective classes, sports, drama, private clubs, committees or a combination thereof. A unique workload profile may be generated for each student and the WMS may then be used to automatically analyze each unique workload profile to provide teachers/administrators visibility into a student's workload. For example, WMS may be used to electronically calculate and provide a view and analysis of the number, type and frequency of a student's activities, and where their time is spent, or predicted to be spent.

Using WMS, schools may then identify students with workload hotspots. In determining workload hotspots, the WMS may, for example, be used to first establish workload thresholds based on, for instance, the total time estimated to complete a set of tasks in a time period and/or the number of complex tasks that can be assigned to an individual in a particular time period.

After establishing these thresholds, WMS may be used to assign tasks such as, homework assignments, assessments, field trips, practices, games, performances and more, so that the due dates, frequency of occurrence and spread over time of these tasks may be optimized. Once the tasks are assigned, WMS may then automatically monitor any exceptions to the established workload thresholds and may inform the relevant school teachers/administrators of such exceptions, i.e., workload hotspots. Once the hotspots are identified early on by WMS, schools may then take action to mitigate stress created by such workload peaks much before it translates into last minute aggravation for the students.

In an alternate embodiment, WMS may also compare how long the tasks are expected to take with how much time they actually take to complete, both for a group of participants and for individual participants thereby allowing teachers and faculty to determine the range of time it takes a group of students to complete an assignment and modify the estimated time based on that feedback.

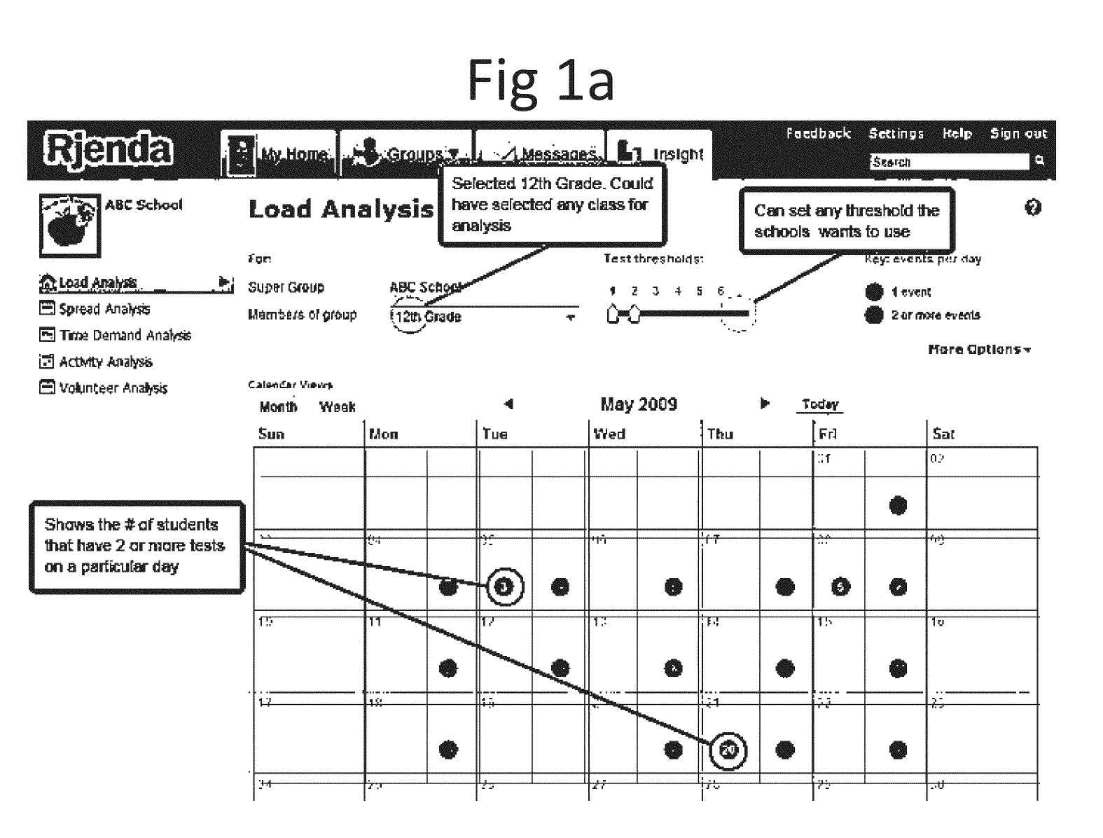

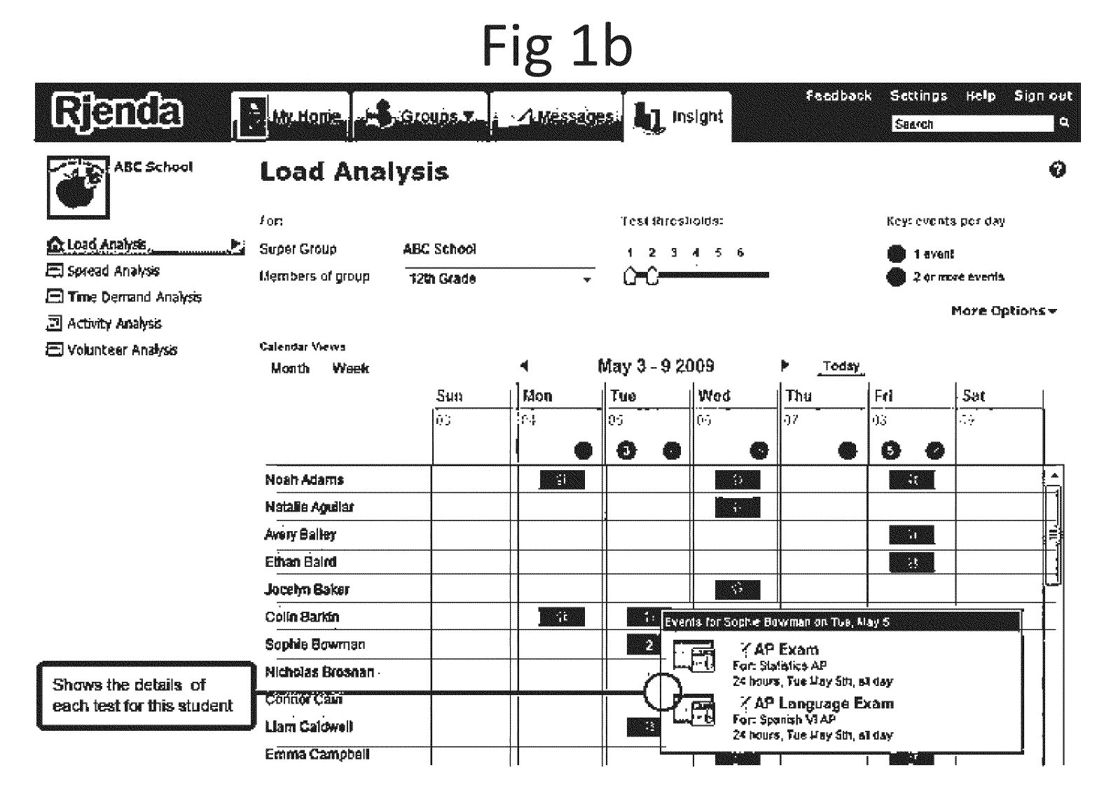

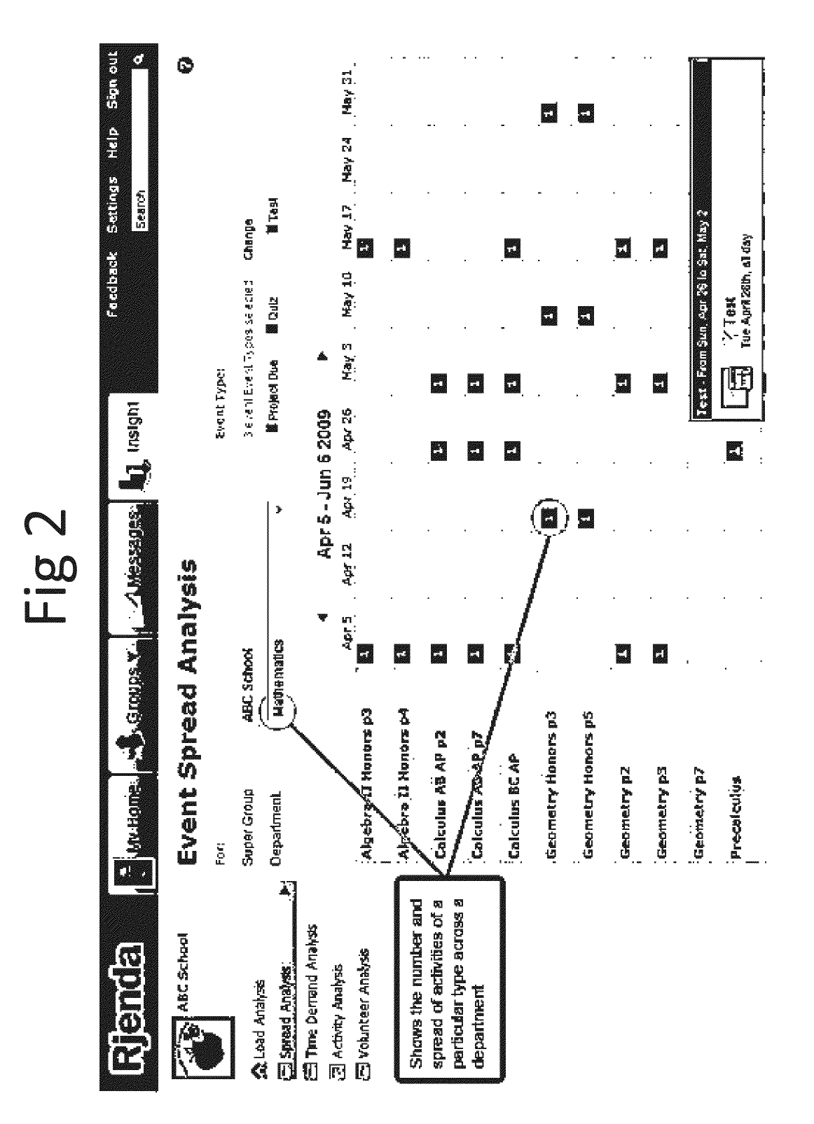

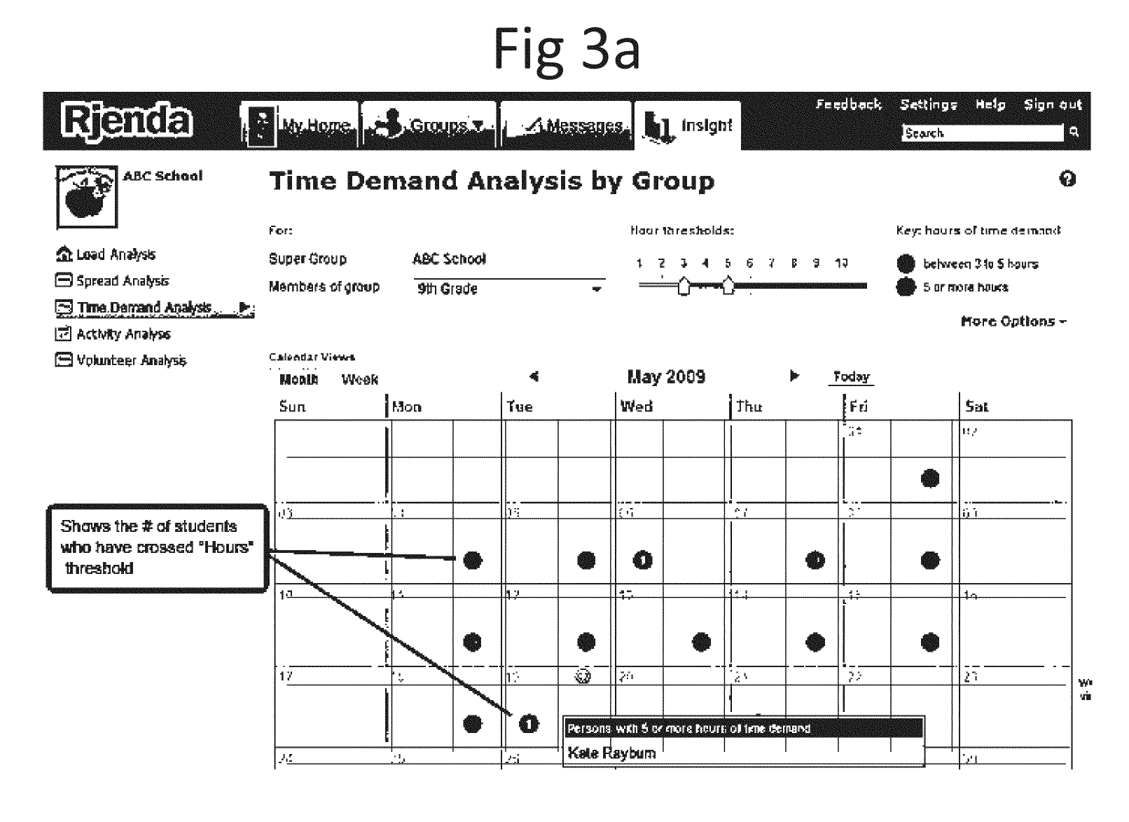

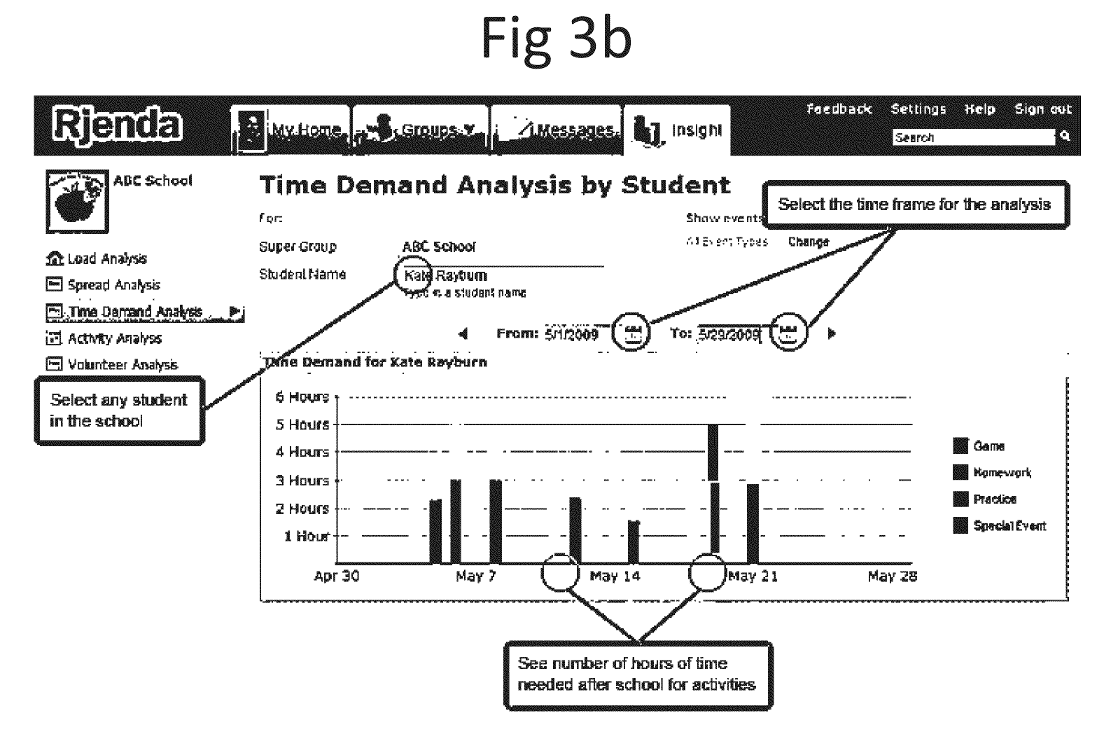

FIGS. 1-9 and 10 provide examples of a workload management system according to one embodiment of the invention. In this embodiment, school administrators (104) may access the workload analytics (107) and student planners (106). School administrators may consist of department heads as well as administrative staff, such as, but not limited to, principals, assistant principals, technology managers, or some combination thereof. When school administrator (104) clicks on a button (not shown) on the Insight tab they may, for instance, have access to all the workload analytics (107). To access the data, a communication may be generated and sent to the Workload Management System (108) which, based on the query criteria, may automatically access the database (109) and files (110) to retrieve and show information about, for example, assessment load analysis (FIG. 1a, b); time demand analysis (FIG. 3a, b); spread analysis (FIG. 2).

A threshold may, for instance, be a limit defined by the school, or some such authority on as to what would constitute a load beyond which students, or an individual student, could be considered overloaded. A hotspot may then be an instance of a student's projected or actual workload reaching or crossing such a threshold.

When the teacher enters new events, assignments or assessments, other teachers and administrators may see this information in the form of workload analysis (111). Alerts and notifications may be sent to all concerned about any exceptions or threshold violations caused as a result thereof (112). As a result, teachers may make necessary adjustments to their class schedules to better balance the workload for students (113), and there may be more meaningful engagement between school community on how best to handle the additional workload or stress caused thereof (114).

FIGS. 1-7 depict an exemplary workload analytics of the WMS. FIG. 1a is a monthly load analysis view of the WMS according to one embodiment of the invention. This view shows the number of people within a class or group that are about to or have gone over a load threshold as defined. In this example, we are seeing the grade 12 students of a High School that have one assessment on any given day and students that have two or more assessments on any given day.

In this exemplary embodiment, users may define and modify the thresholds that may be analyzed and viewed. Users may further see the students who have exceeded a threshold by, for example, positioning the computer mouse over the red-circled number depicting the threshold value. In an alternate embodiment, a user may also click on any of the red-circled number depicting the threshold value and see the details for each of the students that may have violated the threshold. In yet another embodiment, the user may click on, for example, more options and see the types of activities that are to be included for such analysis.

FIG. 1b is a student load analysis view of the WMS according to one embodiment of the invention. This exemplary view of a load analysis shows the details for each student with the number of activities of any particular type they have on any given day. This provides the visibility and insight that school administrators and teachers may need to see a concise summary of upcoming assessments for students in their class and plan their future assessments accordingly. Teachers may, for example, see the precise details of the event and/or activity that the students have on that day.

FIG. 2 is a spread analysis view of the WMS according to one embodiment of the invention. The exemplary spread analysis provides visibility to schools administrators, department heads and teachers to better manage the spread and types of assessments and homework assignments across classes for the academic year.

By way of example FIG. 2 shows all the classes in the Mathematics department of the school—it shows the number of assessments, which, for example, may be of various types such as tests, quizzes, or some combination thereof, and shows homework assignments on any given week. Using this view, the Mathematics department may get visibility into the frequency of overlapping activities of students and their spread across time.

FIG. 3a is a monthly time demand analysis view of the WMS according to one embodiment of the invention. In this exemplary analysis a demand analysis—monthly view—shows the numbers of students who have crossed a time threshold for a particular month. For Example, FIG. 3a shows how many students of the 9th grade in a school have between 3-5 hours or greater than 5 hours of workload after school. Using this exemplary WMS view, teachers and/or administrators may then, for example, mouse-over to see the names of the students with the workload exceptions and can drill into more details about the exception by clicking on the day or going to the week view, as shown in FIG. 3b.

FIG. 3b is a student view of a time demand analysis according to one embodiment of the invention. In this exemplary view, the time demand analysis provides insight into the hours spent by a student on their homework and extracurricular activities outside of classroom time. This helps highlight demand spikes that may cut into sleep and down time, which are essential for any student's good health.

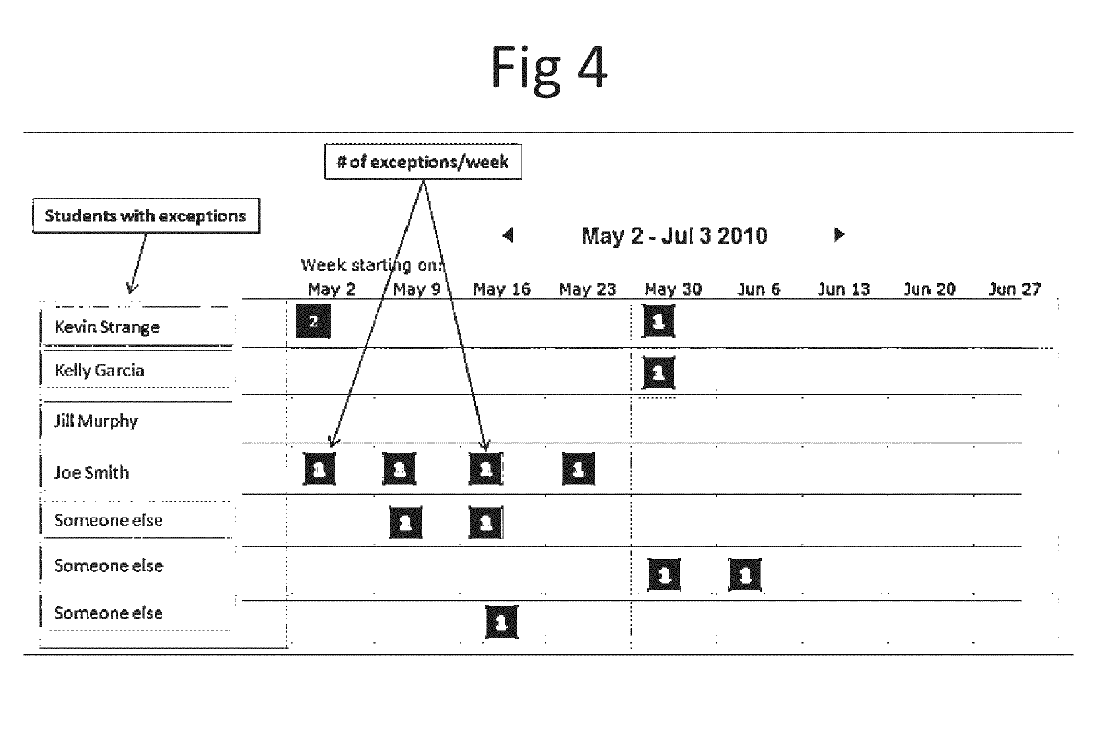

FIG. 4 is an analysis view of students with the workload exceptions over time according to one embodiment of the invention. This exemplary analysis shows the students who have workload exceptions over the course of the school year. It shows the numbers of exceptions each student has per week over time. Teachers and/or other faculty may, for instance, see what each of these exceptions was caused by.

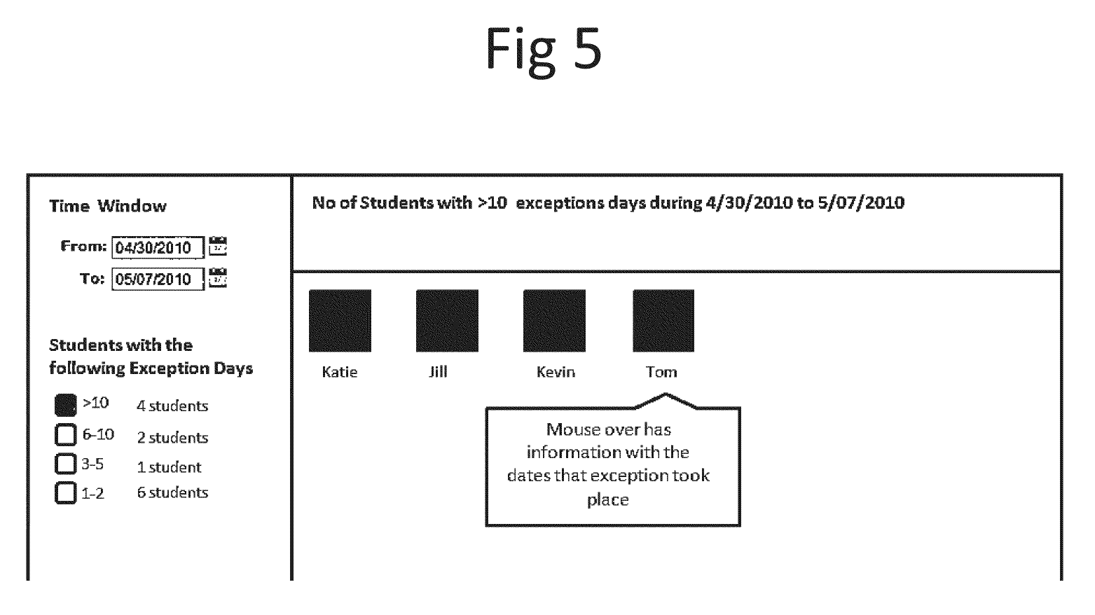

FIG. 5 is an analysis view of students with the workload exceptions over time according to one embodiment of the invention. This analysis shows—over a period of time—the number of exception buckets and how many students are in each of these buckets. For example, when a user clicks on any of these buckets, they may see the individual students impacted and what caused the exceptions.

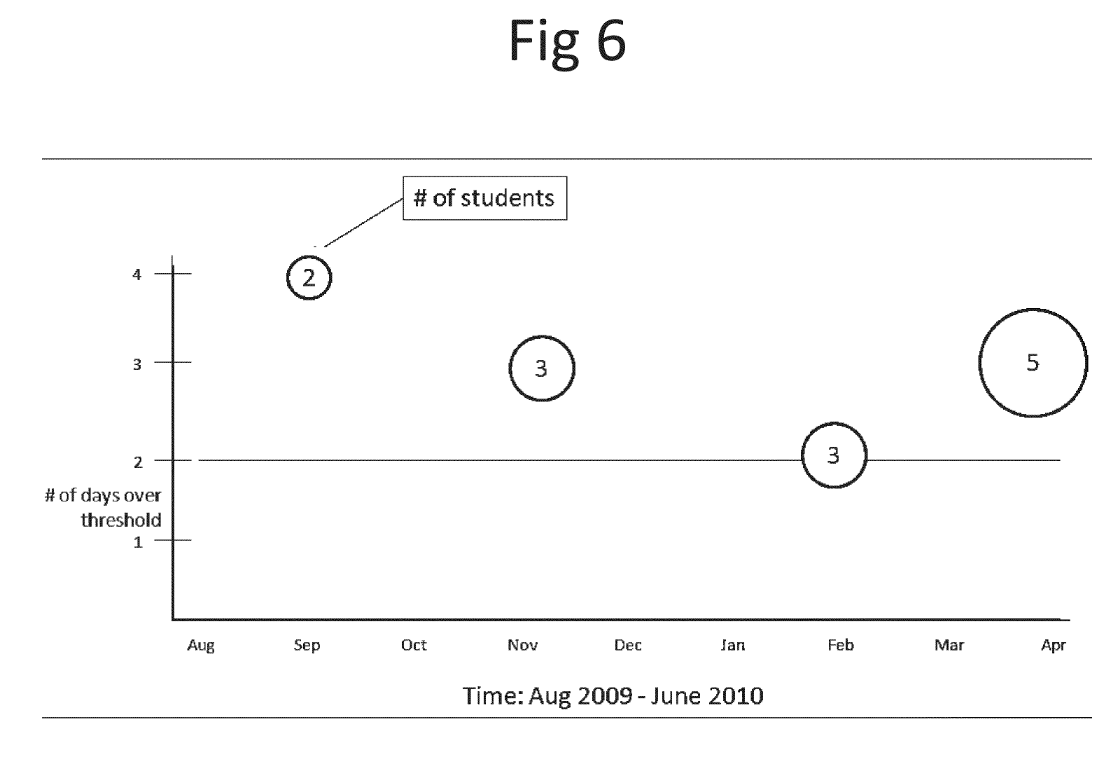

FIG. 6 shows the number of workload exceptions over time and how many students were impacted by each of these exceptions according to one embodiment of the invention. This view, for example, gives a complete view of the workload situation in the school and sets the stage for what the administration should focus to mitigate such workload peaks and exceptions.

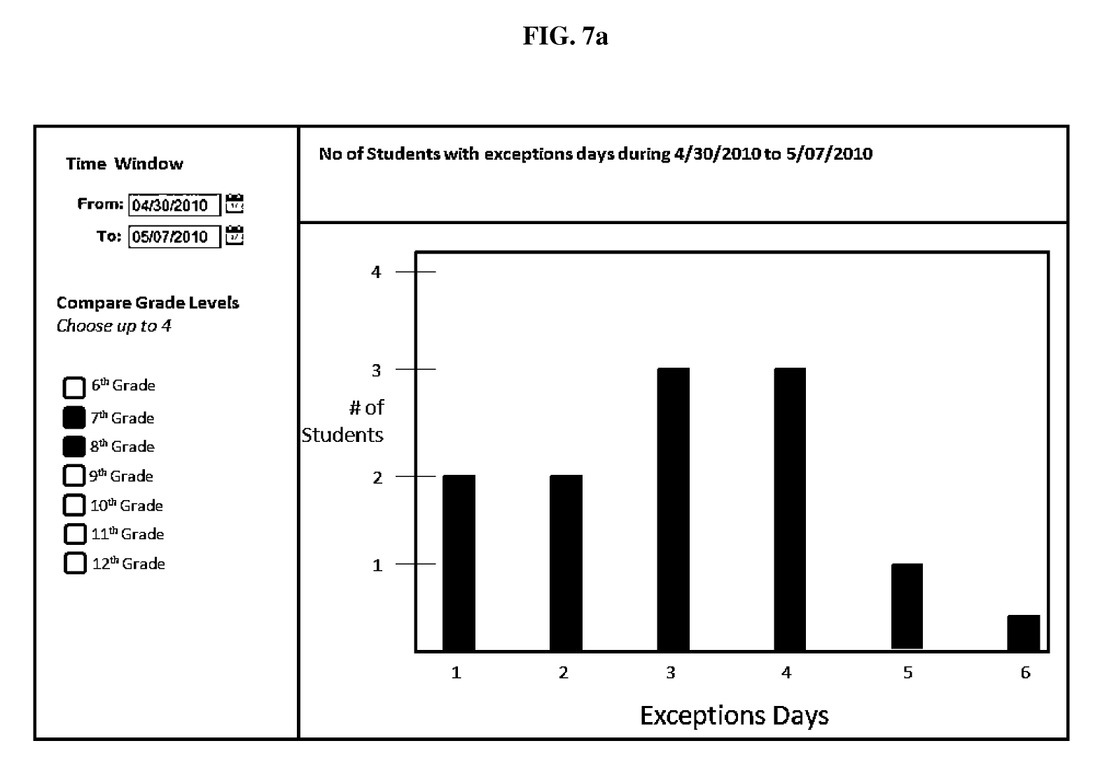

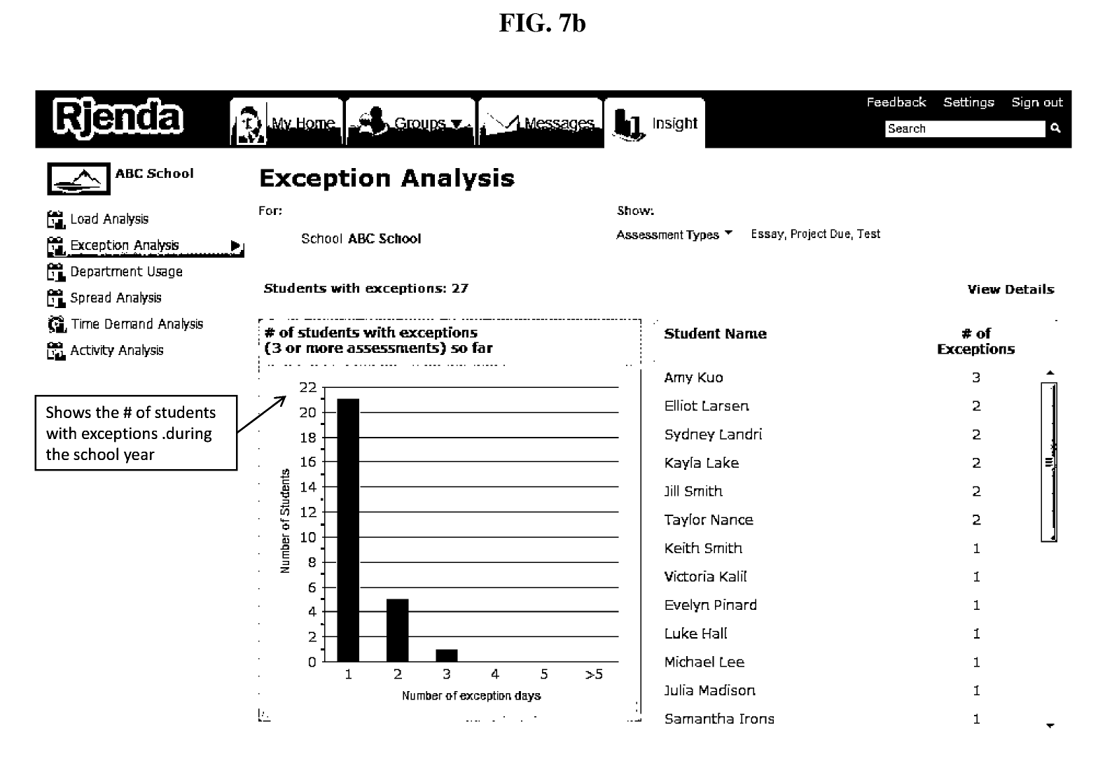

FIG. 7a is an analysis view of students with exception days for a time period by grade according to one embodiment of the invention. This exemplary analysis shows the number of students who have had workload exceptions over a particular time period. This information can, for example, be further refined and compared across grade levels

FIG. 7b is an analysis view of students who have had exception days by having crossed the assessment threshold on any given day. This view shows the number of times assessment load exceptions have taken place during the academic year and the students who are most impacted by such exceptions.

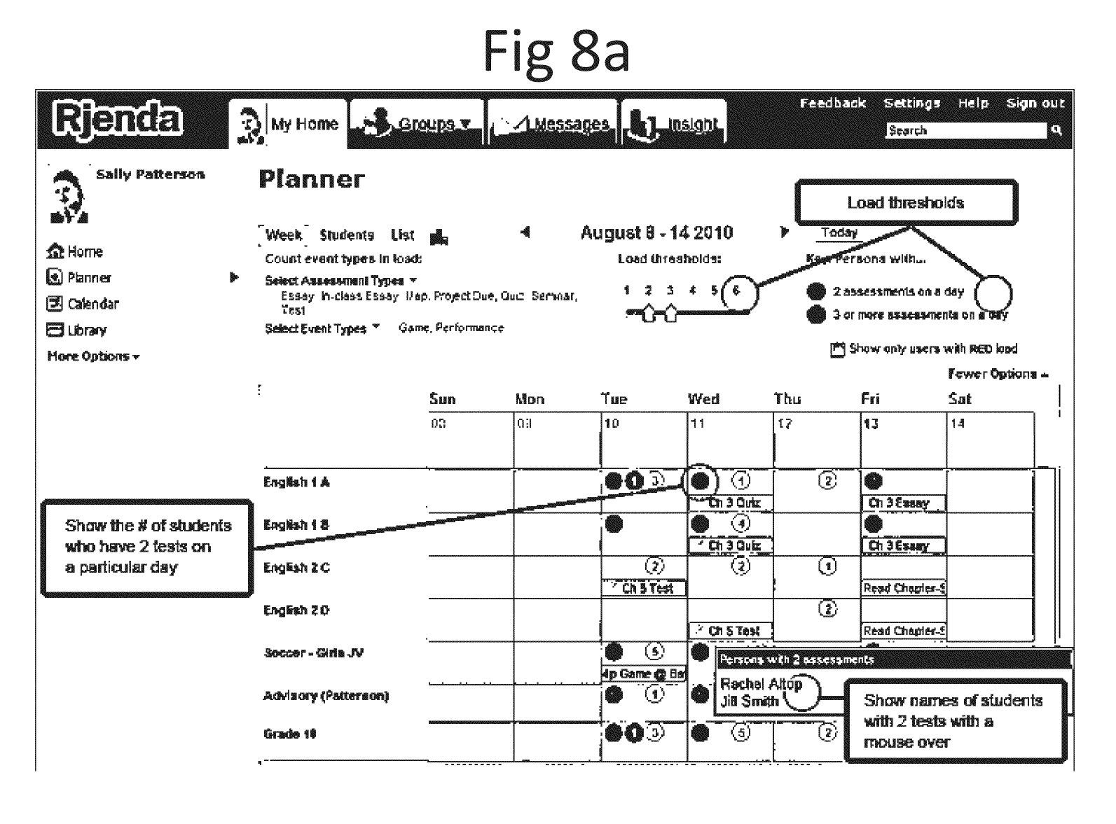

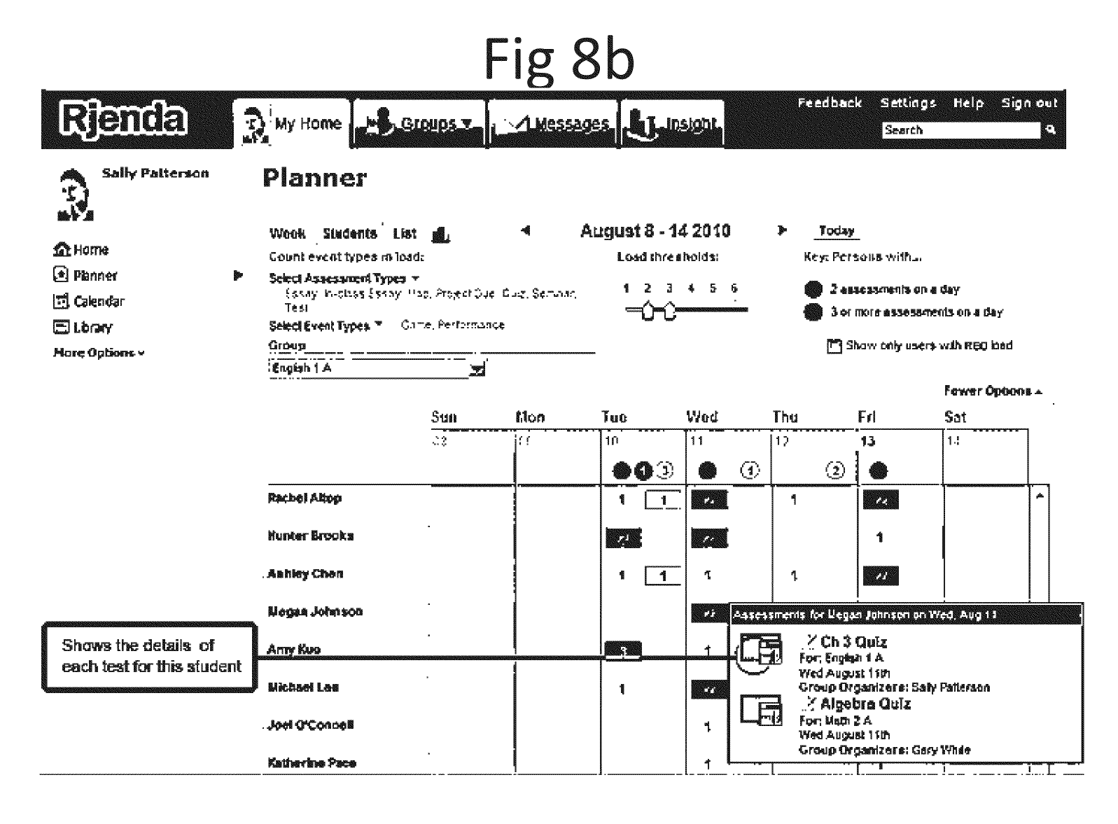

For all the analytics to work in the exemplary system described with reference to FIGS. 1-7 above, teachers and school faculty members may need to enter data about assessments, homework assignments, sporting events and more. One exemplary way is through the WMS planner shown in FIGS. 8a-8b which depicts user views of the teacher planner according to one embodiment of the invention. The planner is one exemplary tool for teachers to input assessments, assignments and events. For teachers to use this effectively, the planner, for example, shows all the classes the teacher teaches, shows the assessments, assignments and events for that class or group, and shows the load for students of that class. In this exemplary embodiment, the load is shown for all students in that class across all the classes they are enrolled in.

FIG. 8a shows all the classes the teacher teaches, the assessments, assignments and events scheduled for those classes. FIG. 8b shows the workload options that can be seen for any of the classes. With this information, displayed by the orange and red circles, the teacher may, for example, see the workload for their students over time and identify days in the week to assign tasks such that workload is well balanced. This exemplary view provides the visibility and insight that school administrators and teachers need to see a concise summary of upcoming assessments for students in their class and plan their future assessments accordingly.

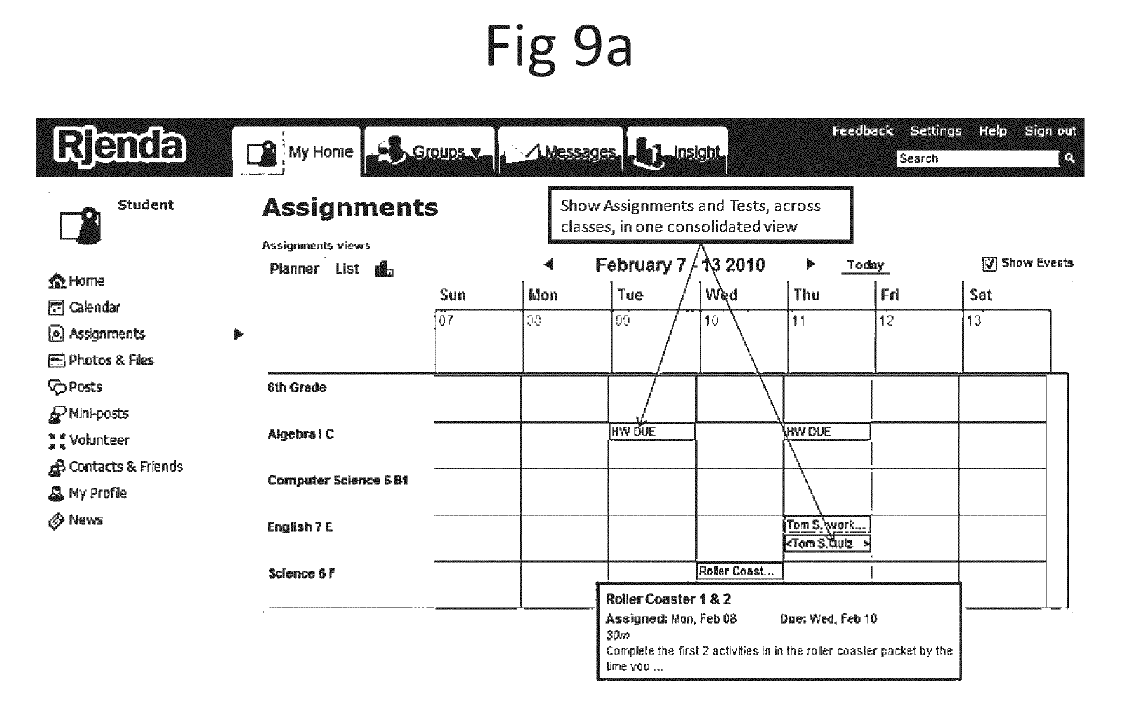

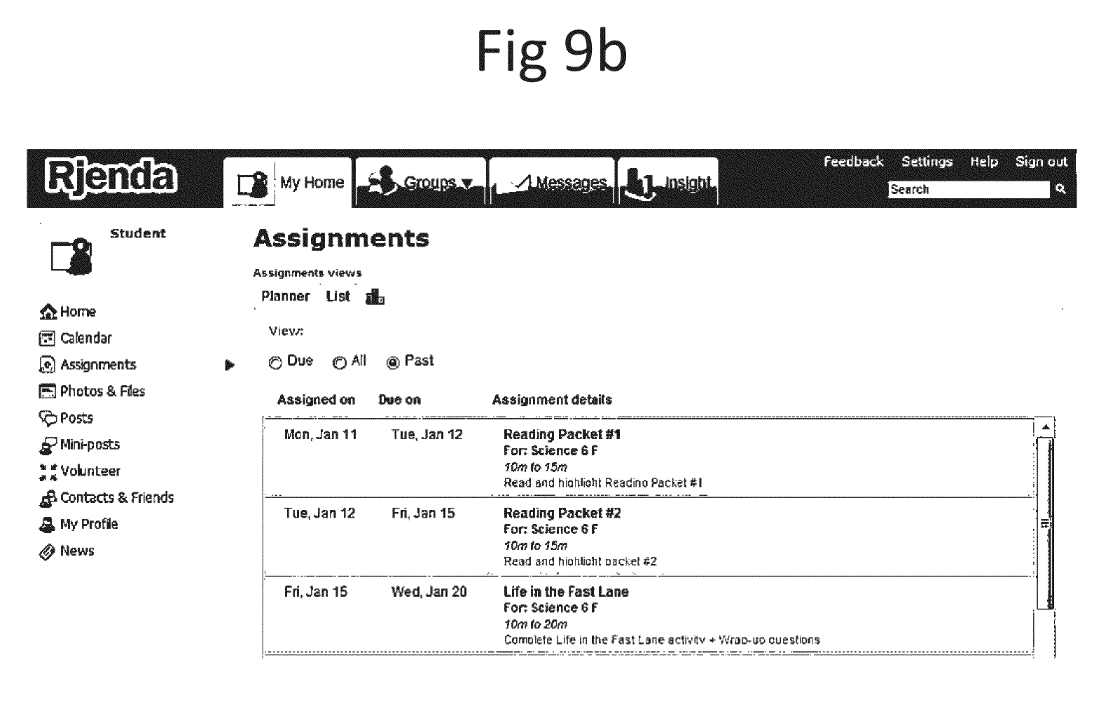

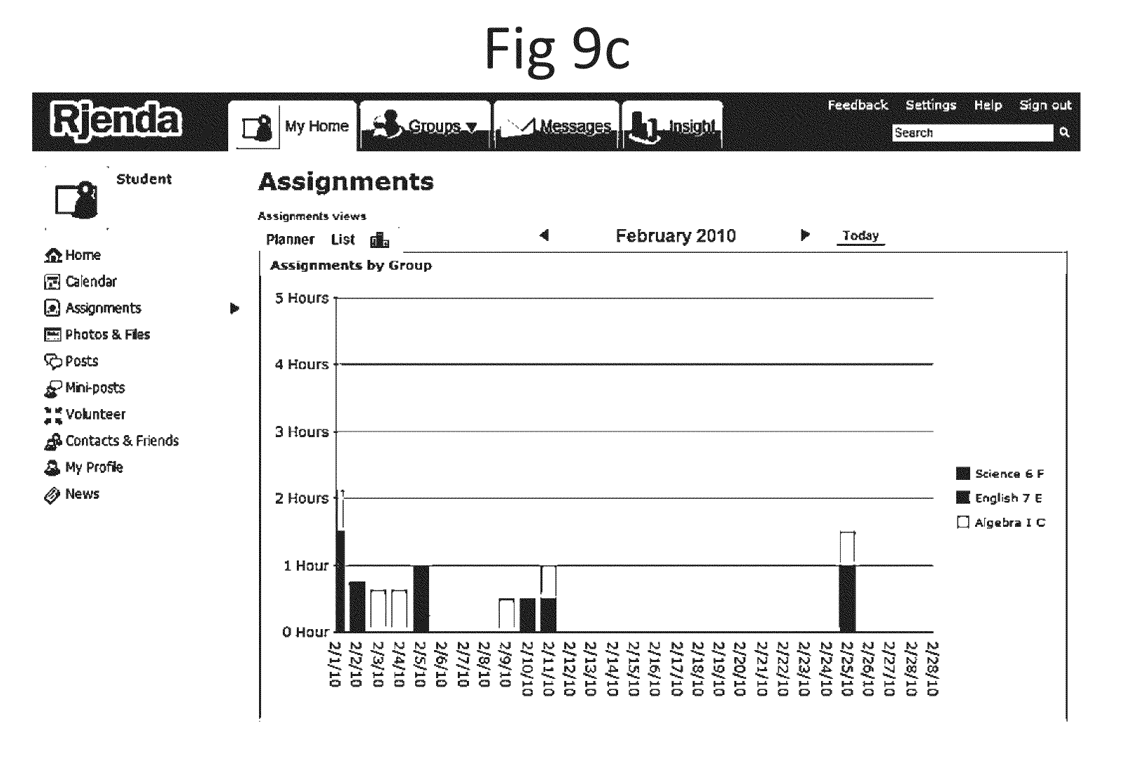

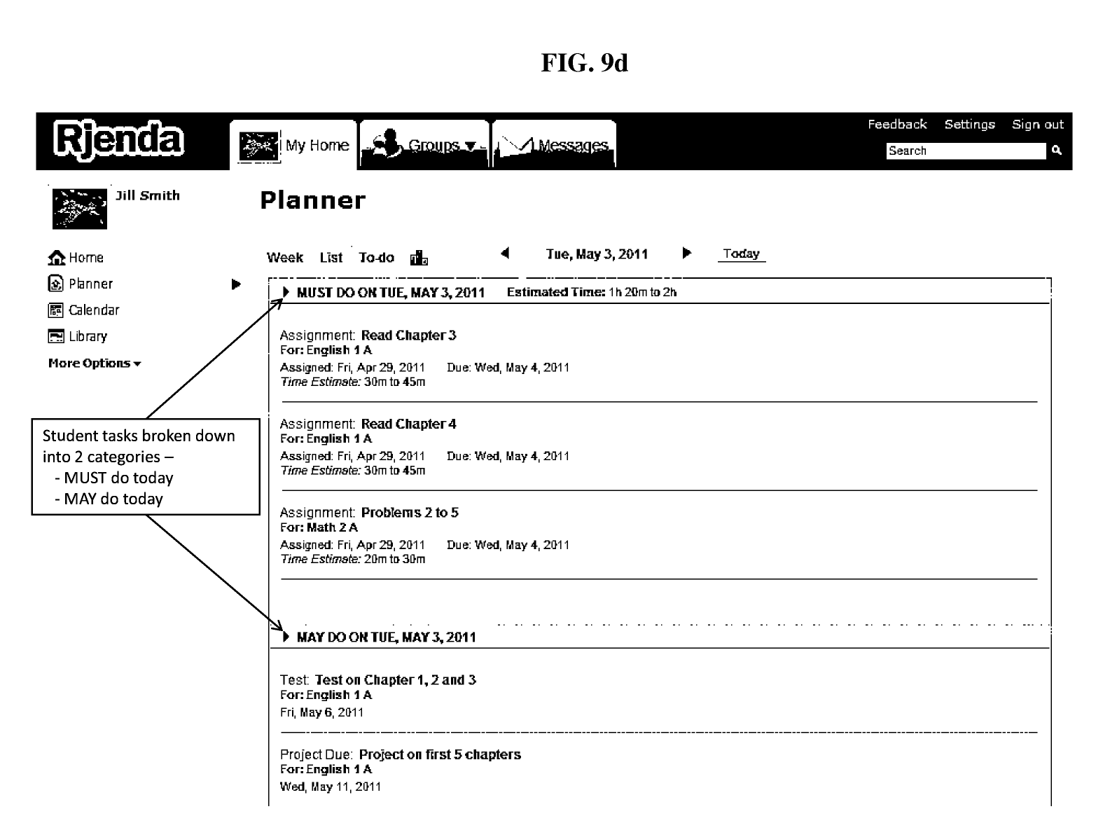

FIGS. 9a-9d depict several exemplary views of the planner for students of the school according to one embodiment of the invention. In these exemplary views, students can (i) see all their classes with assessments, assignments and events across each (FIG. 9a), (ii) see a list of all their assessments, assignments and events, and/or (iii) view a chart of their workload over time, and (iv) see a list of all must-do and may-do activities for any given day. This may be an excellent way for students and their parents to plan activities as they have better visibility into workload peaks.

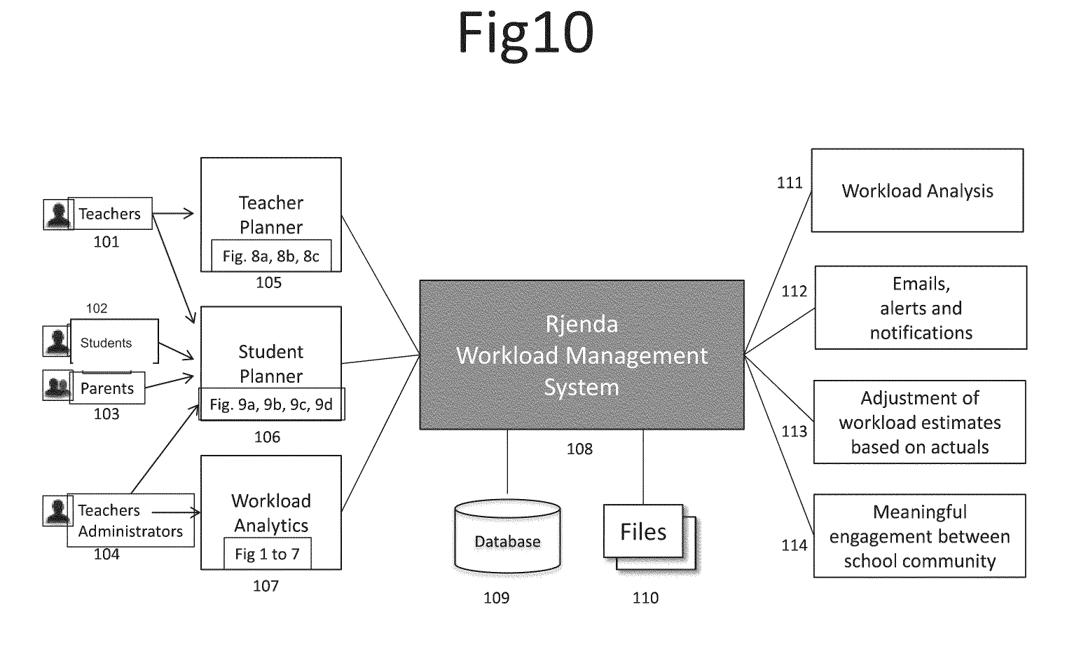

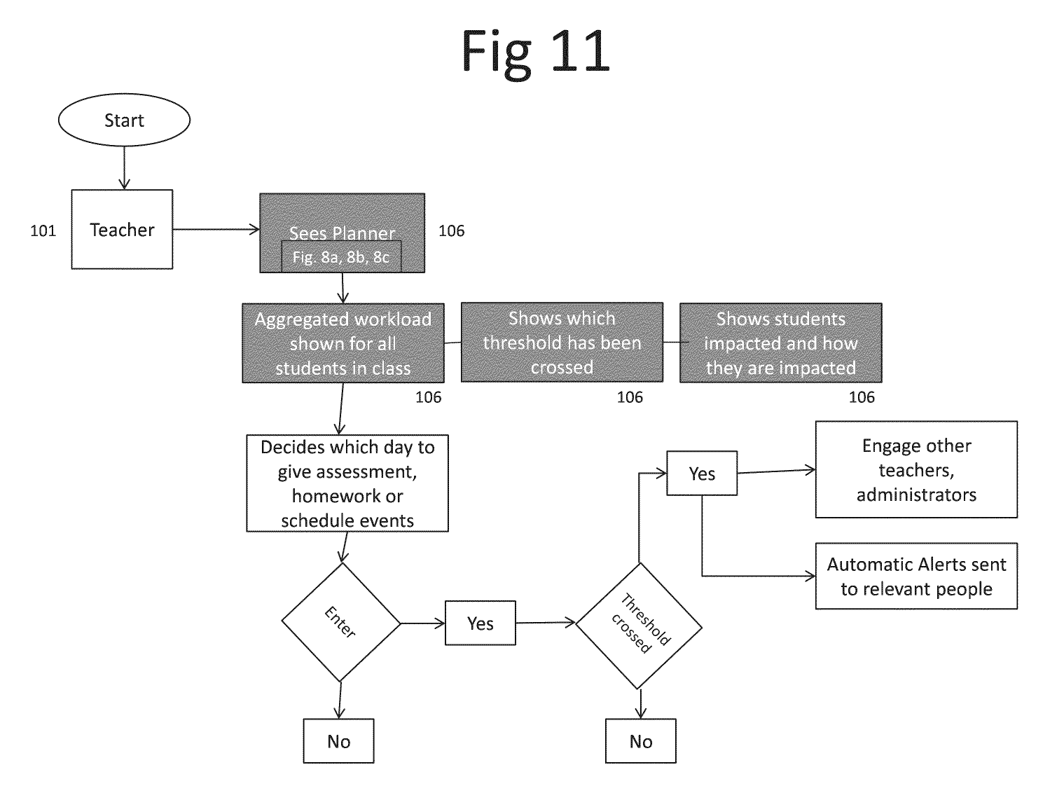

FIG. 10 shows an exemplary interaction and workflow for the key users and components of the Workload Management System (108). FIG. 11 shows an exemplary interaction of a teacher's workflow with the WMS (108). A teacher (101) may access the teacher planner (105) as well as the student planner (106) via the WMS. During use, when the teacher (101) clicks on a button (not shown) on the teacher planner (105) to access the data, a communication may be sent to the Workload Management System (108) which, based on the query criteria, may access the database (109) and files (110) to show information about, for example, workload for all students in the teacher's class; events, assignments and assessments for his/her class; thresholds reached for the students in their class.

In an alternate exemplary interaction, when the teacher enters new events, assignments or assessments, other teachers and administrators may see this information in the form of workload analysis (111). Alerts and notifications may be created and sent to all concerned about any exceptions or threshold violations caused as a result thereof (112). Upon receipt of the alert and/or notification, one or more of the affected teachers can make necessary adjustments to their class schedules to better balance the workload for students (113). In one embodiment of the invention, the WMS may suggest possible adjustments. As a result of these exemplary interactions with the WMS, there may be an improvement over existing systems and a more meaningful engagement between school community on how best to handle the additional workload or stress caused thereof (114).

In yet another alternate interaction, when the teacher (101) clicks on a button (not shown) on the student planner (106) to access the data, a communication may be generated and sent to the Workload Management System (108) which, based on the query criteria, may access the database (109) and files (110) to show information about, for example, the student planner based on the classes the student is enrolled in and the events, assessments and assignments for each of those classes, over time. Exemplary views of the teacher planner are shown in diagrams 8a and 8b.

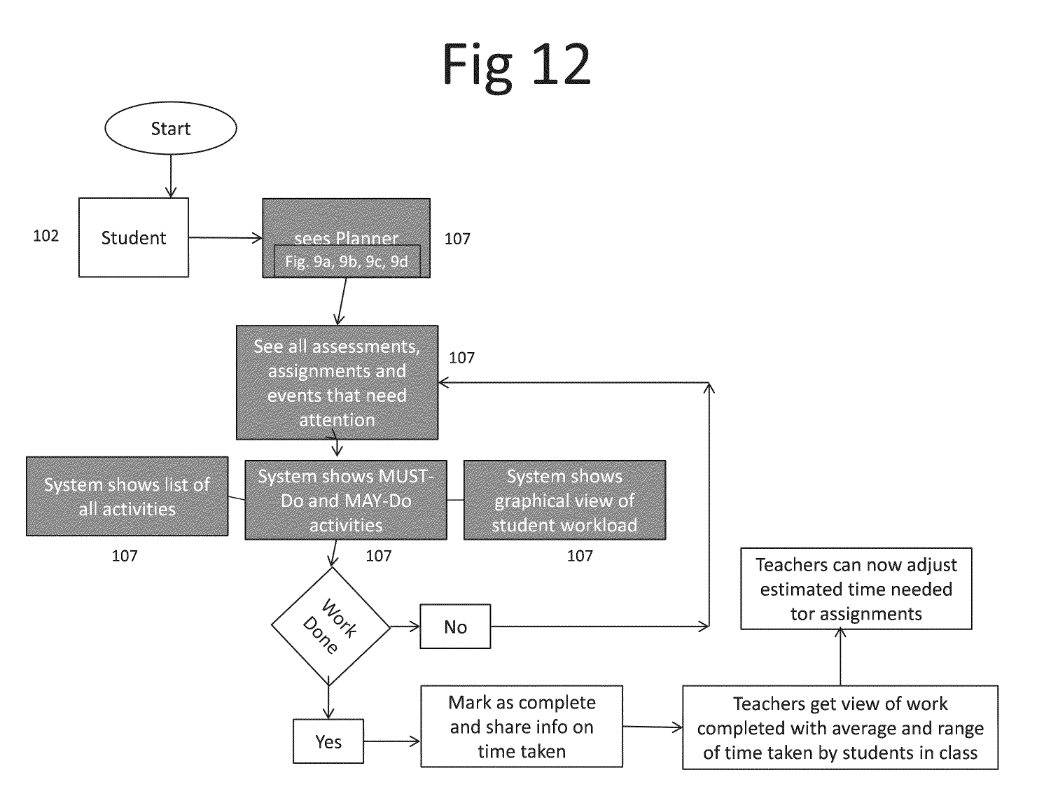

FIG. 12 shows an exemplary interaction of a student's workflow with the WMS (108). A student (102) may access the student planner (106) by clicking on a button (not shown) on the student planner (106) to access the data, at which time, a communication may be generated and sent to the Workload Management System (108) which, based on the query criteria, may access the database (109) and files (110) to show information about, for example, events, assignments and assessments for all the classes and extracurricular activities the student is involved in; a “To-Do” list (FIG. 9d), which lists the activities and tasks the student MUST do on any given day and MAY do on any given day; or a chart that shows their daily workload, that aggregates all the time needed by them to complete their academic and extracurricular activities. Exemplary views of the student planner are shown in diagrams 9a, 9b, 9c and 9d. In an alternate interaction, the student can get a daily email about his/her upcoming events, assignments and assessments (112).

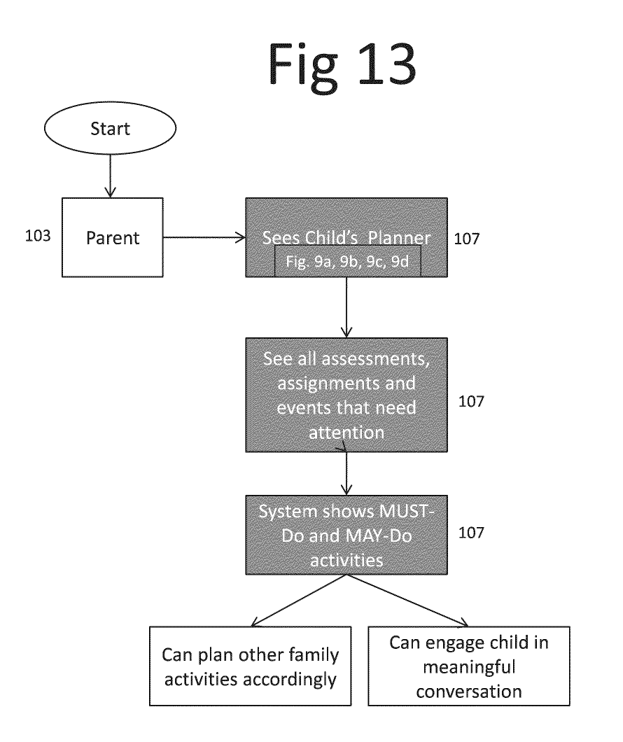

FIG. 13 shows an exemplary interaction of a parent's workflow with the WMS (108). A parent (103) can access their child's (students) planner (106). When the parent (103) clicks on a button (not shown) on the student planner (106) to access the data, a communication may be sent to the Workload Management System (108) which, based on the query criteria, may access the database (109) and files (110) to show information about, for example, events, assignments and assessments for all the classes and extracurricular activities their children (student) is involved in; a “To-Do” list (FIG. 9d), which lists the activities and tasks their children (student) must do (necessary) on any given day and may do (optional) on any given day; or a chart that shows their daily workload, that aggregates all the time needed by their children (students) to complete their academic and extracurricular activities. In an alternate interaction, a parent may receive a daily email about their upcoming events, assignments and assessments for all their children in the school (112).

Workload Management System Controller

As will be known to a person of ordinary skill in the art, the above described exemplary embodiment of a WMS includes a workload management system controller which may be used to implement the foregoing processes. An exemplary WMS controller is based on common computer systems that may comprise, but is not limited to, components such as a computer systemization connected to memory.

Generally, any mechanization and/or embodiment allowing a processor to affect the storage and/or retrieval of information is regarded as memory. It is to be understood that the WMS controller and/or a computer systemization may employ various forms of memory. The memory may also contain a collection of program and/or database modules and/or data such as, but not limited to: operating system module(s), information server module(s), user interface module(s), Web browser module(s), database(s), WMS module(s), and/or the like. These modules may be stored and accessed from the storage devices and/or from storage devices accessible through an interface bus. Although non-conventional software modules such as those in the module collection, typically, are stored in a local storage device, they may also be loaded and/or stored in memory such as: peripheral devices, RAM, remote storage facilities through a communications network, ROM, various forms of memory, and/or the like.

The WMS controller may be connected to and/or communicate with entities such as, but not limited to: one or more users from user input devices, peripheral devices, and/or a communications network. It should be noted that although user input devices and peripheral devices may be employed, the WMS controller may be embodied as an embedded, dedicated, and/or monitor-less (i.e., headless) device, wherein access would be provided over a network interface connection.

The WMS controller serves to process, store, search, serve, identify, instruct, generate, match, and/or update information, expirations, and/or other related data, such as, for example, accessing the database to retrieve and transmit information. The database may communicate to and/or with other modules in a module collection, including itself, and/or facilities of the like.

It is to be understood that the WMS controller affects accessing, obtaining and the provision of information, services, transactions, and/or the like across various communications networks. In one embodiment, the WMS controller employs the web server and user interface modules to obtain user inputs to, for example, specify selection criteria for students. By way of example, one non-limiting exemplary embodiment for the deployment of a workload management system is implemented as an application in accordance with an Internet protocol, such as the HTTP, Extensible Markup Language (“XML”), or HTML protocol.

The configuration of the WMS controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed:

1. A computerized method for managing student workload comprising:
providing a workload management system comprising an electronic controller, an electronic database and one or more machine readable data files;
generating, using said electronic controller, a unique workload profile for one or more students said unique workload profile comprising a compilation of a predicted time of occurrence of each workload task said students is scheduled to participate in during a selected time period, said workload task comprising one of an assignment, and event and an assessment;
establishing workload thresholds for the one or more students, said workload threshold comprising a maximum number of workload tasks that each of said students may participate in during a selected time period;
assigning workload tasks to the one or more students based on the workload threshold for each student;
analyzing, using said electronic controller, the workload profile of each of the one or more students to provide teachers and administrators visibility into one or more student's workload;
identifying students with workload hotspots, said workload hot spot being a time period in which a students workload profile equals or exceeds said student's workload threshold; and
automatically re-assigning workload tasks to the one or more students with workload hotspots to balance the workload for the student.

2. The method of claim 1, further comprising:
presenting the user, via a video display, one or more views related to the workload tasks for each of the one or more students.

3. The method of claim 2, wherein at least one view displays information used to track the cumulative number of hours outside of the school day expected of students for homework and extracurricular activities.

4. The method of claim 2, wherein at least one view is a spread analysis view said view providing visibility to schools administrators, department heads and teachers to better manage the spread and types of workload tasks.

5. The method of claim 2, wherein at least one view is a monthly time demand analysis view showing the numbers of students who have crossed a time threshold for a particular month.

6. The method of claim 2, wherein at least one view is a workload exception view.

7. The method of claim 1, further comprising the step of comparing the school implementing the workload management system against best-practice benchmarks for the one or more student workloads.

8. The method of claim 1, wherein establishing workload thresholds includes that no student should have more than a pre-determined workload tasks on any given day.

9. The method of claim 1, wherein identifying workload hotspots includes one or more of: detecting the occurrence of assessments in excess of a pre-determined threshold; detecting the occurrence time commitments for homework and for extracurricular activities in excess of a pre-determined threshold; or detecting the occurrence of assessments and assignments within a specific duration of time in excess of a pre-determined threshold.

10. The method of claim 1, wherein analyzing the workload profile of each of the one or more students comprises aggregating the workload for a student across their academic and extracurricular activities.

11. The method of claim 1, wherein re-assigning workload tasks includes bringing the workload hotspots to attention of teachers, administrators and parents who can then take mitigating action.

12. The method of claim 11, wherein teachers and school administrators are automatically notified of workload hotspots.

13. The method of claim 12, wherein the notification varies with the role of the recipient of information.

14. The method of claim 8, wherein the pre-determined workload tasks includes pre-determining one or more of load, time demand and spread and frequency of assessments and for the one or more students.

15. A system for managing student workload comprising:
providing an electronic workload management system for prioritizing and managing student activities;
generating, using said electronic workload management system, a unique workload profile for one or more students;
establishing workload thresholds for the one or more students;
assigning workload tasks to the one or more students based on the workload threshold for each student;
analyzing the workload profile of each of the one or more students to provide teachers and administrators visibility into one or more student's workload;
identifying students with workload hotspots; and
re-assigning workload tasks to the one or more students with workload hotspots to balance the workload for the student.

16. A computerized system for managing student workload comprising:
a workload management device comprising an electronic controller, an electronic database and one or more machine readable data files;
a unique workload profile for one or more students, said workload profile being generated using said electronic controller, and wherein said unique workload profile comprises a compilation of a predicted time of occurrence of each workload task said students are scheduled to participate in during a selected time period, said workload tasks comprising assignments, events and assessments;
a workload threshold for the one or more students, said workload threshold comprising a maximum number of workload tasks that each of said students may participate in during a selected time period;
an assigned workload task, assigned to the one or more students based on the workload threshold for each student;
an analysis of the workload profile of each of the one or more students obtained using said electronic controller, the analysis configured to provide teachers and administrators visibility into one or more student's workload;
an identified student having a workload hotspot, said workload hotspot being a time period in which a students workload profile equals or exceeds said student's workload threshold; and
an automatic re-assignment of one or more workload tasks to the one or more students with workload hotspots to balance the workload for the student.

17. A data storage device comprising machine readable instructions for implementing a student workload management method, said method comprising:
providing a workload management system comprising an electronic controller, an electronic database and one or more machine readable data files;
generating, using said electronic controller, a unique workload profile for one or more students said unique workload profile comprising a compilation of a predicted time of occurrence of each workload task said students are scheduled to participate in during a selected time period, said workload task comprising one of an assignment, and event and an assessment;
establishing workload thresholds for the one or more students, said workload threshold comprising a maximum number of workload tasks that each of said students may participate in during a selected time period;
assigning workload tasks to the one or more students based on the workload threshold for each student;
analyzing, using said electronic controller, the workload profile of each of the one or more students to provide teachers and administrators visibility into one or more student's workload;
identifying students with workload hotspots, said workload hot spot being a time period in which a students workload profile equals or exceeds said student's workload threshold; and
automatically re-assigning workload tasks to the one or more students with workload hotspots to balance the workload for the student.
